(19) United States
(12) Patent Application Publication
(10) Pub. No.: US 2025/0156976 A1
(43) Pub. Date: May 15, 2025

(54) CHILD DRAWING UNDERSTANDING AND ANALYSIS REPORTING SYSTEM

(71) Applicant: i-Scream arts Co.,Ltd., Seoul (KR)

(72) Inventors: Yeonji Baik, Seoul (KR); Sooleen Nam, Gwangju-si (KR); Yujin Lee, Seoul (KR)

(21) Appl. No.: 18/935,679

(22) Filed: Nov. 4, 2024

(30) Foreign Application Priority Data
Nov. 9, 2023 (KR) 10-2023-0154449

(51) Int. Cl. G06Q 50/22; G06T 7/90; G06V 10/26

(52) U.S. Cl. CPC G06Q 50/22; G06T 7/90; G06V 10/273; G06T 2207/10

(57) ABSTRACT

The present disclosure relates to a child drawing understanding system, and more particularly, to a child drawing understanding and analysis reporting system. To this end, a child drawing understanding and analysis reporting method including a step (S100) of inputting information about an electronic child drawing to a controller (100), by a client computer (120), a pre-processing step (S200) of removing a predetermined object from the child drawing, by the controller (100), a step (S300) of generating analysis data by performing a predetermined analysis on the pre-processed child drawing based on an object and a color, by the controller (100), a step (S400) of calculating an interpretation indicator by inputting the analysis data to a service model by the controller (100), and. a step (S500) of generating and outputting an analysis report based on the interpretation indicator, by the controller (100) is provided.

### CROSS-REFERENCE TO RELATED APPLICATIONS

This application claims the priority of Korean Patent Application No. 10-2023-0154449 filed on Nov. 9, 2023, in the Korean Intellectual Property Office, the disclosure of which is incorporated herein by reference.

### BACKGROUND

### Field

The present disclosure relates to a drawing understanding system, and more particularly, to child drawing understanding and analysis reporting system.

### Description of the Related Art

The commonly known art therapy technique is a method for diagnosing and treating a psychological and emotional state of a child and analyzes and interprets colors used by a child to draw a picture to indirectly find out the child's inner emotional state. When a child chooses a specific color to paint, it is understood that it includes information about the child's psychological state or emotional characteristics.

Accordingly, art therapists bring up fairly accurate information about the psychological state from the relatively meager response represented in such a child's drawing. For example, children's drawings are useful in the treatment of depression, stress, aesthetic sensitivity, artistry, and various types of social avoidance and the psychotherapy and are also utilized to evaluate the attention deficit and hyperactivity disorder (ADHD).

The evaluation and interpretation of the children's drawing were the domain of professional art therapists or clinical/counseling experts and there was no system to systematically accumulate and automate the evaluation and interpretation as data. Accordingly, there was a limitation that the objectivity of the drawing interpretation was low due to the variety of range of the interpretation according to evaluator's experience, carrier, and an evaluation situation.

Therefore, there is a need to develop an objective and standardized system for understanding, analyzing, and evaluating children's drawings.

### RELATED ART DOCUMENT

### Patent Document

Patent Document 1: Korean Registered Patent No. 10-0935013 (Method for analysis of coloring patterns in art therapy assessment and medium of recording its program)
Patent Document 2: Korean Unexamined Patent Application Publication No. 10-2022-0108451 (Service and method for platform-based art education and consultation)

### SUMMARY

The present disclosure is devised to solve the above-described problems and an object to be achieved by the present disclosure is to provide an objective and standardized system for understanding, analyzing, and evaluating a child's drawing.

Another object of the present disclosure is to provide a child drawing understanding and analysis reporting system which interprets color elements and objects from a child's drawing to analyze a child's coloring tendency.

Another object of the present disclosure is to provide a child drawing understanding and analysis reporting system which analyzes an emotion and psychology from the characteristics of colors and coloring of the child's drawing and predicts a general tendency of the child or predicts the child's interest and carrier direction therefrom.

However, technical objects to be achieved in the present disclosure are not limited to the aforementioned technical objects, and another not-mentioned technical object will be clearly understood by those skilled in the art from the description below.

In order to achieve the above-described technical objects, a child drawing understanding and analysis reporting method includes a step S100 of inputting information about an electronic child drawing to a controller 100, by a client computer 120; a pre-processing step S200 of removing a predetermined object from the child drawing, by the controller 100; a step S300 of generating analysis data by performing a predetermined analysis on the pre-processed child drawing based on an object and a color, by the controller 100; a step S400 of calculating an interpretation indicator by inputting the analysis data to a service model by the controller 100; and a step S500 of generating and outputting an analysis report based on the interpretation indicator, by the controller 100.

Further, the input step S100 includes at least one of: a step S110 of inputting a file of the child drawing; a step S120 of inputting a meta file of the child drawing; a step S130 of inputting meta information about a child who draws the child drawing; and a step S140 of inputting feedback information about the child or the child drawing which is generated by a teacher of the child.

In the pre-processing step S200, the predetermined object is at least one of a teacher's drawing drawn by the teacher, a background drawing, and a white background color if the drawing is drawn by the child and the teacher together.

The pre-processing step S200 includes: a step S210 of removing a teacher's drawing drawn by the teacher from the child drawing when the child and the teacher draw the drawing together; a step S220 of removing a background drawing from the child drawing; a step S230 of removing a background color from the child drawing; and a step S240 of assigning a penalty to an achromatic color in the child drawing.

Further, the analysis data generating step S330 includes at least one of: a step S310 of recognizing an object in the child drawing; a step S320 of recognizing colors of the child drawing: a step S330 of recognizing lines of the child drawing; a step S340 of recognizing spaces of the child drawing; and a step S350 of analyzing behavior data of the child.

In the step S310 of recognizing objects of the child drawing, the number of objects and sizes of the objects are recognized and in the step S320 of recognizing colors of the child drawing, at least one of a coloring ratio, a primary color, a primary color usage ratio, a hue type, a tone ratio, and a color usage difference (std) are recognized, in the step S330 of recognizing lines of the child drawing, at least one of a pen pressure, a length, a thickness, a repetition, the number of times, and a speed of the lines is recognized, in the step S340 of recognizing spaces of the child drawing, at least one of an occupancy ratio and a placement of the object is recognized, and in the child behavior data analysis step S350, at least one of a drawing hour and the number of correction is analyzed.

The interpretation indicator calculating step S400 includes at least one of a step S410 of diagnosing and testing the child drawing by a drawing diagnosis test model 141; a step S420 of clinically classifying the child drawing, by a child clinical classification model 142; a step S430 of classifying a general tendency of the child who draws the child drawing, by a child general tendency classification model 143; a step S440 of analyzing a development of the child drawing, by a child drawing development model 144; and a step S450 of analyzing the child drawing, by a child drawing analysis model 145; and a step S460 of storing and outputting an interpretation indicator output from the service model.

Further, the drawing diagnosis test model outputs a stress indicator and a copying resource indicator as the interpretation indicator, the child clinical classification model includes a depression indicator, an anxiety indicator, and an ADHD indicator as the interpretation indicator, the child general tendency classification model includes a realistic indicator, an exploratory indicator, and an artistic indicator as the interpretation indicator, the child drawing development model includes a scribbling stage indicator, a preschematic stage indicator, and a schematic stage indicator, as the interpretation indicator, and the child drawing analysis model includes an aesthetic sensitivity indicator and an immersion indicator as the interpretation indicator.

Further, the analysis report output step S500 includes a step of performing at least one of a step S510 of generating a drawing diagnosis test report 161; a step S520 of generating a child emotion/psychology analysis report 162; a step S530 of generating a child tendency/carrier path analysis report 163; a step S540 of generating a child artistic tendency report 164; and a step S550 of generating an Art BONGBONG growth report 165, based on the interpretation indicator; and a step S560 of outputting the generated report.

The drawing diagnosis test report 161, the child artistic tendency report 164, and the Art BONGBONG growth report 165 are based on the interpretation indicators of the drawing diagnosis test model, the child drawing development model, and the child drawing analysis model, respectively and the child emotion/psychology analysis report 162 and the child tendency/career path analysis report 163 are based on the interpretation indicators of the child clinical classification model 142 and the child general tendency classification model 143, respectively.

According to the exemplary embodiment of the present disclosure, it is possible to quickly confirm an objective and standardized understanding, analysis, and evaluation report on the child's drawing. Therefore, it is possible to quickly check the analysis report on the child by inputting the drawing of the child anywhere, regardless of locations, if the Internet access is available.

Further, the child's color tendency, child's aesthetic ability, artistic tendency, and areas of interest can be predicted by interpreting color elements and objects from the child's drawing.

An emotion and psychology are analyzed from the characteristics of colors and coloring of the child's drawing and a general tendency of the child is predicted or the child's interest and carrier direction are predicted therefrom.

A technical object to be achieved in the present disclosure is not limited to the aforementioned effects, and another not-mentioned effect will be obviously understood by those skilled in the art from the description below.

### BRIEF DESCRIPTION OF THE DRAWINGS

The following drawings attached to this specification illustrate exemplary embodiments of the present disclosure and, together with the detailed description of the present disclosure to be described below, are provided for better understanding of the technical spirit of the present disclosure, and therefore, the present disclosure should not be interpreted as being limited to matters described in such drawings:

FIG. 1 is a schematic flowchart of a child drawing understanding and analysis reporting method according to an exemplary embodiment;

FIG. 2 is a schematic diagram of a child drawing understanding and analysis reporting system according to an exemplary embodiment;

FIG. 3 is a detailed flowchart of an information input step S100 of FIG. 1;

FIG. 4 is a detailed flowchart of a pre-processing step S200 of FIG. 1;

FIG. 5 is a detailed flowchart of an analysis step S300 of FIG. 1;

FIG. 6 is a detailed flowchart of an interpretation indicator calculating step S400 of FIG. 1;

FIG. 7 is a detailed flowchart of an analysis report output step S500 of FIG. 1.

FIG. 8 is a Kobayashi image scale used for color analysis of the present disclosure; and

FIG. 9 is an example of an art BONGBONG learning report according to an exemplary embodiment of the present disclosure.

### DETAILED DESCRIPTION OF THE INVENTION

In the following detailed description, only certain exemplary embodiments of the present invention have been shown and described, simply by way of illustration. Description of the present invention is just an embodiment for structural and functional description so that the scope of the present invention is not interpreted to be limited by the embodiment described in the specification. That is, the embodiment may be modified in various forms so that it is understood that the scope of the present invention has equivalents which are capable of implementing the technical spirit. Further, it does not mean that the specific embodiment includes the object or effect proposed in the present invention or includes only the effect so that it is not understood that the scope of the present invention is limited thereby.

In the meantime, meanings of terms described in the present invention can be understood as follows.

The terms “first” or “second” are used to distinguish one component from the other component so that the scope should not be limited by these terms. For example, a first component may be referred to as a second component, and similarly, a second component may be referred to as a first component. It should be understood that, when it is described that an element is “connected” to another element, the element may be directly connected to the other element or connected to the other element through a third element. In contrast, it should be understood that, when it is described that an element is directly connected to another element, no element is present between the element and the other element. Other expressions which describe the relationship between components, that is, “between” and “directly between”, or “adjacent to” and “directly adjacent to” need to be interpreted by the same manner.

Unless the context apparently indicates otherwise, it should be understood that terms “include” or “have” indicate that a feature, a number, a step, an operation, a component, a part or the combination thereof described in the specification is present, but do not exclude a possibility of presence or addition of one or more other features, numbers, steps, operations, components, parts or combinations thereof, in advance.

Unless they are contrarily defined, all terms used herein including technological or scientific terms have the same meaning as those generally understood by a person with ordinary skill in the art. Terms which are defined in a generally used dictionary should be interpreted to have the same meaning as the meaning in the context of the related art but are not interpreted as an ideally or excessively formal meaning if it is not clearly defined in the present invention.

### Configuration of Exemplary Embodiment

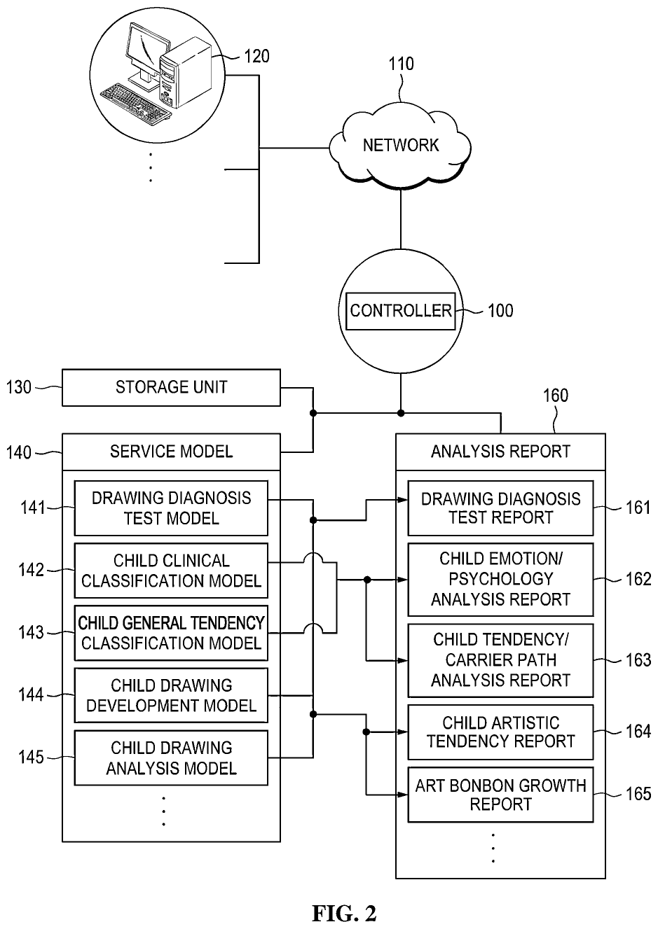

Hereinafter, preferred exemplary embodiments will be described in detail with reference to the accompanying drawings. FIG. 2 is a schematic diagram of a child drawing understanding and analysis reporting system according to an exemplary embodiment. As illustrated in FIG. 2, a client computer 120 is connected to a network 110 and transmits and receives data through the network. The client computer 120 may be a personal computer, a tablet, a notebook, or a mobile phone including a camera, a scanner, or an USB port to input a drawing created by a child.

The network 110 may transmit data between the client computer 120 and a controller 100, in a wired or wireless manner. To this end, the network 110 may be Internet, Intranet, LAN, 4G, or 5G communication networks or may be a near-field communication network such as WiFi or Bluetooth.

The controller 100 may be a computer or a server which is connected to the network 110. To this end, the controller 100 executes a database, an operating program (for example, Windows or UNIX), or an application program (for example, a drawing analysis program).

A storage unit 130 stores various data for a file executed by the controller 100. The storage unit 130 stores information about an input child's drawing, a generated analysis report, client information, and log data. To this end, the storage unit 130 may be RAM, ROM, a hard disk, a flash memory, SSD, an optical disk, or a magnetic tape.

The service model 140 is a group of application programs including sub-models for generating a report. Such a service model 140 includes a drawing diagnosis test model 141, a child clinical classification model 142, a child general tendency classification model 143, a child drawing development model 144, and a child drawing analysis model 145 therein, and further includes an additional model.

The analysis report 160 is a result output from the service model 140 and is a content provided to a member (or a client). Such an analysis report 160 includes a drawing diagnosis test report 161, a child emotion/psychology analysis report 162, a child tendency/carrier path analysis report 163, a child artistic tendency report 164, and an Art BONGBONG growth report 165.

For example, the drawing diagnosis test report 161 is generated using the drawing diagnosis test model 141, the child drawing development model 144, and the child drawing analysis model 145.

The child emotion/psychology analysis report 162 is generated using the child clinical classification model 142 and the child general tendency classification model 143.

The child tendency/carrier path analysis report 163 is generated using the child clinical classification model 142 and the child general tendency classification model 143.

The child artistic tendency report 164 is generated using the drawing diagnosis test model 141, the child drawing development model 144, and the child drawing analysis model 145.

The Art BONGBONG growth report 165 is generated using the drawing diagnosis test model 141, the child drawing development model 144, and the child drawing analysis model 145.

### Operation of Exemplary Embodiment

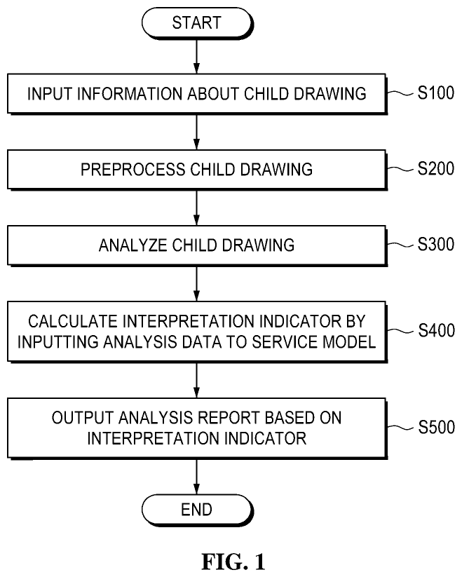

Hereinafter, an operation of the preferred exemplary embodiments will be described in detail with reference to the accompanying drawings. FIG. 1 is a schematic flowchart of a child drawing understanding and analysis reporting method according to an exemplary embodiment. As illustrated in FIG. 1, first, the client computer 120 inputs information about an electronic child drawing to the controller 100 (S100).

Next, in a pre-processing step S200, the controller 100 removes a previously specified object from the child drawing.

Next, in a step S300, the controller 100 generates analysis data by performing a predetermined analysis on the pre-processed child drawing based on an object and a color.

Next, in a step S400, the controller 100 calculates an interpretation indicator by inputting the analysis data to a service model.

Next, in a step S500, the controller 100 generates and outputs an analysis report based on the interpretation indicator. Hereinafter, sub steps of each of the above-described steps S100 to S500 will be described in detail.

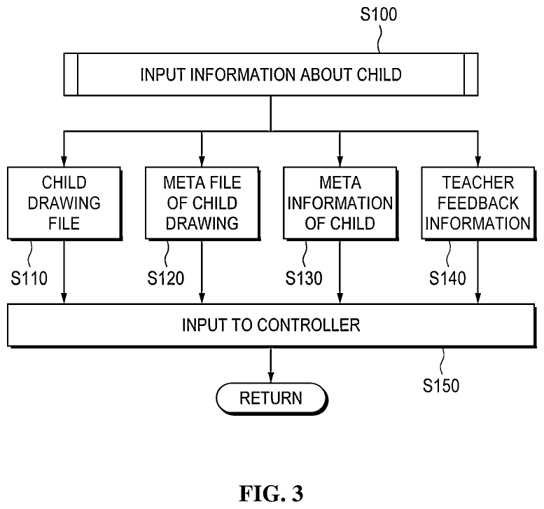

First, FIG. 3 is a detailed flowchart of an information input step S100 of FIG. 1. As illustrated in FIG. 3, in the input step S100, a member converts a drawing created by a child into an image file to input (S110). To this end, the image file may be a JPG file which is captured by a camera, or scanned by a scanner, or directly drawn on the tablet with an electronic pen.

A metafile of the child drawing is input (S120). The metafile includes meta information of the child drawing and the meta information includes a file name, date and time of birth, a file size, a file type, or a capturing or scan option.

Meta information about a child who draws the child drawing is input (S130). The meta information about the child includes a name, a birth date, a gender, school information, and health information of the child.

Feedback information about the child or the child drawing which is generated by a teacher of the child is input (S140). As the feedback information, information about the child personality, grade, and school life is input numerically (for example, 1 to 10 levels). The input steps S110 to S140 may be sequentially or randomly performed and some steps may be omitted.

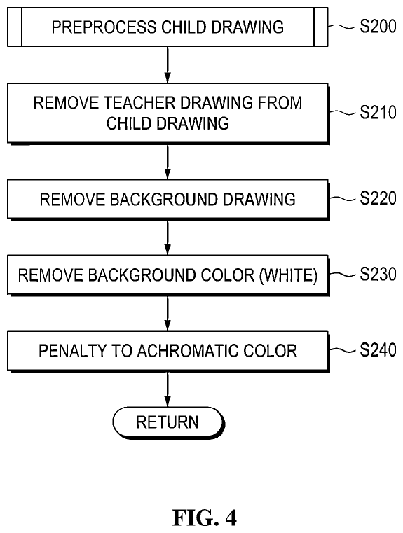

FIG. 4 is a detailed flowchart of a pre-processing step S200 of FIG. 1. As illustrated in FIG. 4, when a child and a teacher draw the drawing together, a teacher's drawing is removed from the child drawing (S210). This is to prevent the drawing of the teacher from affecting the analysis of the child. If the drawing is drawn by the child alone, the step S210 may be omitted. Next, a background picture is removed from the child drawing (S220). By doing this, an object to be analyzed may be more clarified. Next, a background color (for example, white) is removed from the child drawing (S230). Next, a penalty is assigned to an achromatic color of the child drawing (S240). When a dark achromatic color including black is used, an error may occur in color analysis and interpretation (specifically, color “emotion” analysis and interpretation). Accordingly, when the black is used to sketch, the achromatic penalty is assigned. That is, a sketch drawing and a color drawing are primarily classified and then a penalty for the achromatic color is assigned. A case that the black is used to sketch is as follows: After extracting an outline of the drawing, a coordinate value of the outline and a coordinate value of the black are compared to evaluate the similarity. When the similarity is high, a high achromatic penalty is assigned and when the similarity is low, a low achromatic penalty is assigned.

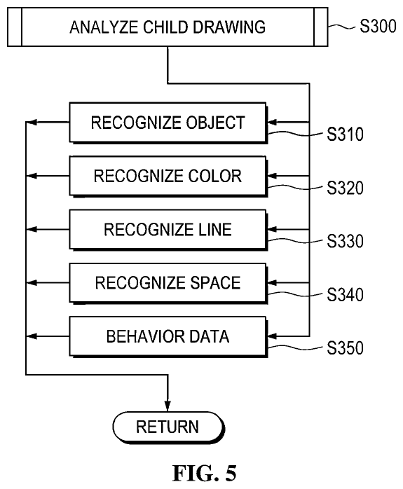

FIG. 5 is a detailed flowchart of an analysis step S300 of FIG. 1. As illustrated in FIG. 5, first, an object (for example, people, a house, and a tree) of the child drawing is recognized (S310). The number of recognized objects and a size (area) of the object are recognized.

A color (for example, yellow, red, or green) of the child drawing is recognized (S320). To be more specific, a coloring ratio, a mainly used color (primary color), a primary color usage ratio, a hue type, a tone ratio, and a color usage difference (std) are recognized. Hue is a color type and indicates a value of a specific color having an RGB value, such as red or yellow. In the present exemplary embodiment, it corresponds to one color value, among 130 colors of Kobayashi.

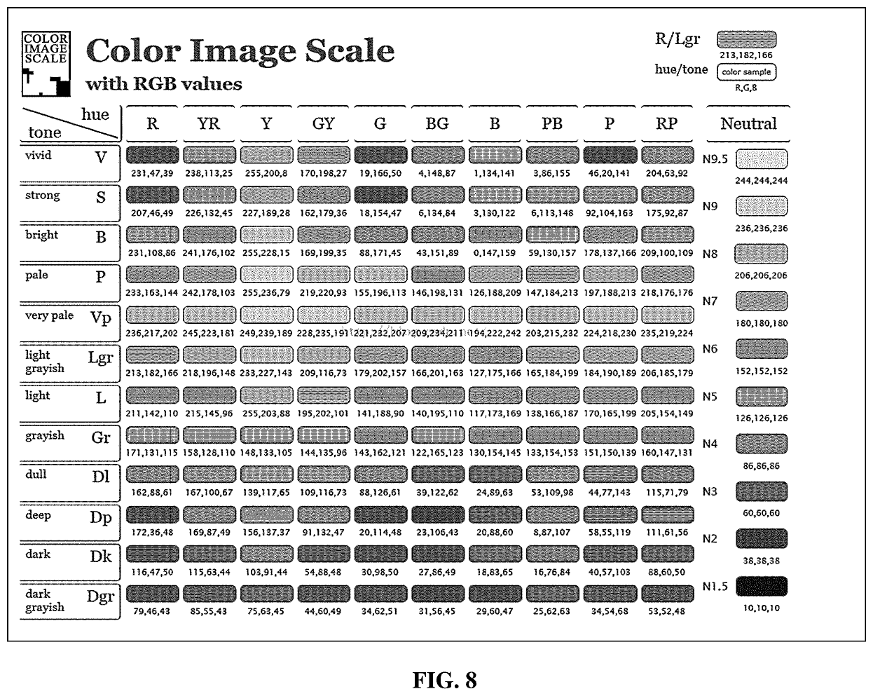

The color used for color analysis uses 130 color image scales of Kobayashi as illustrated in FIG. 8. A developed color emotion model (two-dimensional color image model) may be constructed based on the following color and emotion models. That is, the color image model is (1) practical color coordinate system (PCCS), (2) Kobayashi color image scale, (3) image search institute Inc. (I.R.I.) color image scale. Further, the emotion model is a PA emotion model which is abbreviated as a core affect, among PAD emotion models. The emotion model includes Paul Ekman's seven basic emotions: anger, surprise, disgust, sadness, fear, enjoyment, and contempt.

A PCCS color system which is an example of a color image model is a color system which is announced by Japan Color Research Institute in 1964 that divides colors into 12 tones. Kobayashi color image scale is a color image scale which is configured by 130 hues and tones by Kobayashi of Japan. I. R. I. color image scale is a color analysis tool and a color image space indicator configured by 120 and 880 hues and tones, which are developed by Korea color design Inc. in 1992.

The PAD emotional state model is a psychology model which is developed by Albert Mehrabia and James A. Russel (since 1974) to explain and measure an emotional state. P stands for pleasure, A stands for arousal, and D stands for Dominance and all emotions are expressed using three numerical dimensions. Among the PAD emotional state models, a model which is abbreviated as a core element is a PA emotional model.

Each color element value is automatically extracted from the child drawing using these models. As the color element value extracted from the drawing, the closest color is extracted by evaluating a similarity of a lot of actually used colors with Kobayashi's 130 colors. Even if the RGB values are the same, the colors which actually appear on the canvas may be produced differently due to slight differences in hue and tone.

A color element used in the exemplary embodiment of the present disclosure is as follows. An area usage rate (%), a background rate (%), an outline ratio (%), an achromatic outline ratio (%), a color usage rate (%), the number of colors used (n), a primary color usage rate (%), the number of primary colors used (n), a hue usage rate (%), a tone usage rate (%), and a difference in color usage (std). For example, the difference in color usage amount (std) means a different degree between a main color which is frequently used and an auxiliary color which is less used.

If the color element value is extracted, a standardizing process of color element values is performed. Units of all coordinate values are unified so that the color elements can be compared and the type can be classified.

Optionally, a color emotional element is extracted from the child drawing. First, the color emotional element is divided into color emotion extraction for a single color and color emotion extraction for a color combination that best represents the feeling and a mood of the drawing. From the single color, a representative emotion value (for example, positive-non-arousal drawing P+A−), each emotion usage (%), the difference in emotion usage (std), and an emotion distribution rate (%) are extracted. For example, each emotion usage (%) represents a usage of each of four zones (a first quadrant, a second quadrant, a third quadrant, and a fourth quadrant) according to the degree of positive-negative, arousal-non-arousal. Next, a color emotion word (adjectives) is extracted based on the used color.

A line (for example, a straight line or a curved line) of the child drawing is recognized (S330). For example, a pen pressure, a length, a thickness, a repetition, the number of times, and a speed of the line may be recognized.

A space (for example, a load, a mountain, and a building) of the child drawing is recognized (S340). Specifically, an occupancy ratio and a placement of the object may be recognized.

Behavior data (for example, a drawing hour and the number of corrections) of the child is analyzed (S350). The analysis steps S310 to S350 may be sequentially or randomly performed and some steps may be omitted.

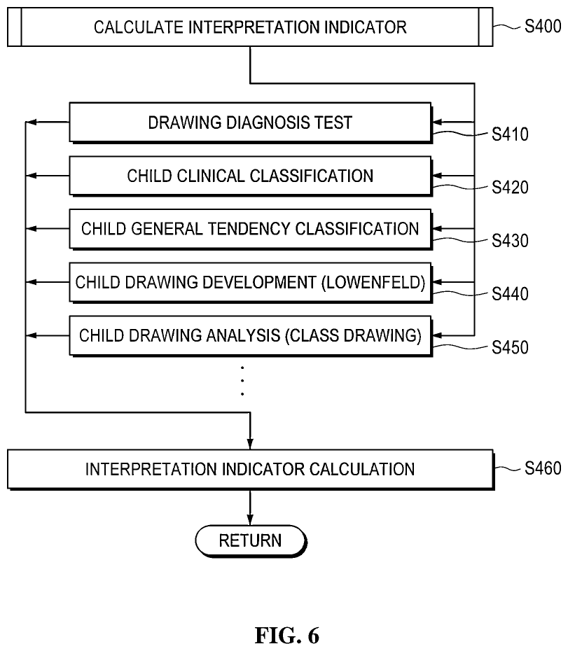

FIG. 6 is a detailed flowchart of an interpretation indicator calculating step S400 of FIG. 1. As illustrated in FIG. 6, the drawing diagnosis test model 141 outputs an analysis indicator and an interpretation indicator derived through the analysis of the child drawing (S410). The child clinical classification model 142 clinically classifies the child drawing and outputs a depression indicator, an anxiety indicator, and an ADHD indicator (S420). The child general tendency classification model 143 classifies the general tendency of a child who draws the child drawing and outputs a realistic indicator, an exploratory indicator, and an artistic indicator (S430). The child drawing development model 144 analyzes the development of child's drawing using the Lowenfeld method and outputs a scribbling stage indicator, a preschematic stage indicator, and a schematic stage indicator (S440).

The scribbling stage is a first stage of the child artistic development stages claimed by Lowenfeld, V. and a stage where children cannot control their arms with their own will and draw large and small circles continuously, and do not intentionally select colors but use whatever they have at hand. The preschematic stage is a second stage of the child artistic development stages claimed by Lowenfeld, V. and a state where intentional expression begins, and children subjectively diagram objects and draw them by selecting colors according to their subjective feelings. The schematic stage is a third stage of a child artistic development stages claimed by Lowenfeld, V. and a stage where the concept of shape is formed and the ability and judgment to find a certain concept of an object are developed.

The child drawing analysis model 145 analyzes a child drawing (which is drawn during the class) to output an aesthetic sensitivity indicator and an immersion indicator (S450). The aesthetic sensitivity indicator (color sensitivity indicator) is an indicator of how sensitive and sensible one is to colors, such as color sensitivity and color harmony.

These steps S410 to S450 may be sequentially or randomly performed and some steps may be omitted.

Next, the controller 100 generates, stores, and outputs an interpretation indicator based on information generated in the above-described steps S410 to S450.

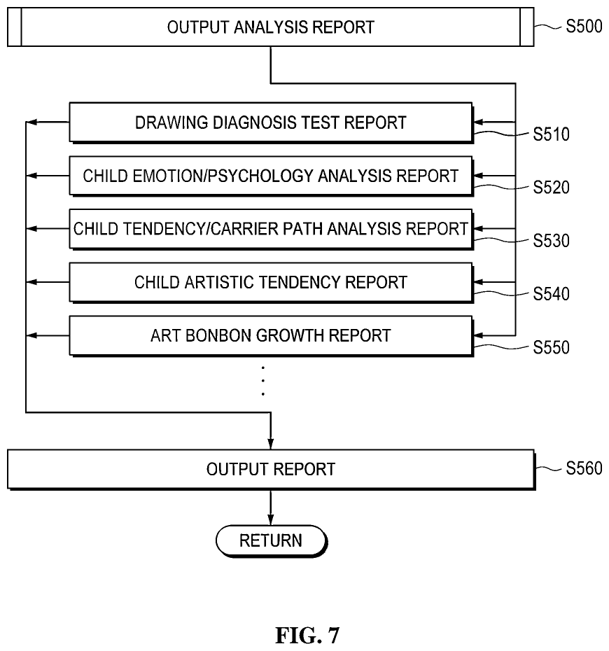

FIG. 7 is a detailed flowchart of an analysis report output step S500 of FIG. 1. As illustrated in FIG. 7, the controller 100 generates a drawing diagnosis test report 161 based on the interpretation indicators of the drawing diagnosis test model 141, the child drawing development model 144, and the child drawing analysis model 145 (S510).

The controller 100 generates the child emotion/psychology analysis report 162 based on the interpretation indicators of the child clinical classification model 142 and the child general tendency classification model 143 (S520).

The controller 100 generates the child tendency/carrier path analysis report 163 based on the interpretation indicators of the child clinical classification model 142 and the child general tendency classification model 143 (S530).

The controller 100 generates a child artistic tendency report 164 based on the interpretation indicators of the drawing diagnosis test model 141, the child drawing development model 144, and the child drawing analysis model 145 (S540).

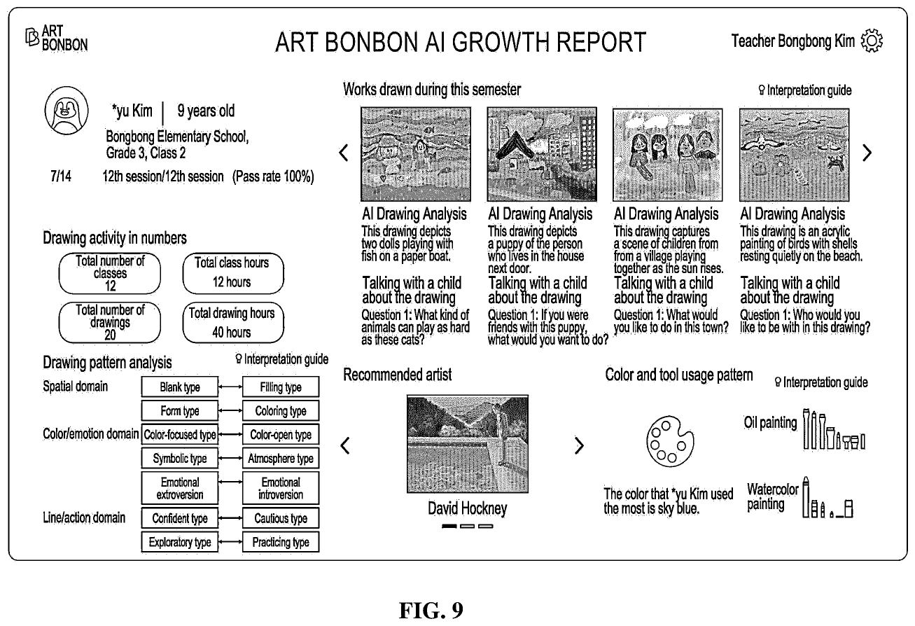

The controller 100 generates an Art BONGBONG growth report 165 based on the interpretation indicators of the drawing diagnosis test model 141, the child drawing development model 144, and the child drawing analysis model 145 (S550). FIG. 9 is an example of an Art BONGBONG learning report according to an exemplary embodiment of the present disclosure. As illustrated in FIG. 9, in the art BONGBONG learning report, personal information about a child, a drawing activity (including an activity time) in numbers, analysis of a drawing pattern (color usage statistics, tool usage statistics, a time-series analysis of color usage) are graphically displayed together with texts.

The steps S510 to S550 may be sequentially or randomly performed and some steps may be omitted according to the selection of the member.

Next, the controller 100 outputs the reports generated in the above-described steps S510 to S550 (S560). In order to output the report, the report is transmitted to the client computer 120 to be displayed or printed.

As described above, the detailed description of the exemplary embodiments of the disclosed present invention is provided such that those skilled in the art implement and carry out the present invention. While the invention has been described with reference to the preferred embodiments, it will be understood by those skilled in the art that various changes and modifications of the present invention may be made without departing from the spirit and scope of the invention. For example, those skilled in the art may use configurations disclosed in the above-described exemplary embodiments by combining them with each other. Therefore, the present invention is not intended to be limited to the above-described exemplary embodiments but to assign the widest scope consistent with disclosed principles and novel features.

The present invention may be implemented in another specific form within the scope without departing from the spirit and essential feature of the present invention. Therefore, the detailed description should not restrictively be analyzed in all aspects and should be exemplarily considered. The scope of the present invention should be determined by rational interpretation of the appended claims and all changes are included in the scope of the present invention within the equivalent scope of the present invention. The present invention is not intended to be limited to the above-described exemplary embodiments but to assign the widest scope consistent with disclosed principles and novel features. Further, claims having no clear quoting relation in the claims are combined to configure the embodiment or may be included as new claims by correction after application.

1. A child drawing understanding and analysis reporting method, comprising:
a step (S100) of inputting information about an electronic child drawing to a controller (100), by a client computer (120);
a pre-processing step (S200) of removing a predetermined object from the child drawing, by the controller (100);
a step (S300) of generating analysis data by performing a predetermined analysis on the pre-processed child drawing based on an object and a color, by the controller (100);
a step (S400) of calculating an interpretation indicator by inputting the analysis data to a service model by the controller (100); and.
a step (S500) of generating and outputting an analysis report based on the interpretation indicator, by the controller (100).

2. The child drawing understanding and analysis reporting method according to claim 1, wherein the input step (S100) includes at least one of:
a step (S110) of inputting a file of the child drawing;
a step (S120) of inputting a metafile of the child drawing;
a step (S130) of inputting meta information about a child who draws the child drawing; and
a step (S140) of inputting feedback information about the child or the child drawing, generated by a teacher of the child.

3. The child drawing understanding and analysis reporting method according to claim 1, wherein in the pre-processing step (S200), the predetermined object is at least one of a teacher's drawing drawn by the teacher, a background drawing, and a white background color if the drawing is drawn by the child and the teacher together.

4. The child drawing understanding and analysis reporting method according to claim 3, wherein the pre-processing step (S200) includes:
a step (S210) of removing a teacher's drawing drawn by the teacher from the child drawing when the child and the teacher draw the drawing together;
a step (S220) of removing a background drawing from the child drawing;
a step (S230) of removing a background color from the child drawing; and
a step (S240) of assigning a penalty to an achromatic color in the child drawing.

5. The child drawing understanding and analysis reporting method according to claim 1, wherein the analysis data generating step (S330) includes at least one of:
a step (S310) of recognizing an object in the child drawing;
a step (S320) of recognizing colors of the child drawing;
a step (S330) of recognizing lines of the child drawing;
a step (S340) of recognizing spaces of the child drawing; and
a step (S350) of analyzing behavior data of the child,
to generate the analysis data.

6. The child drawing understanding and analysis reporting method according to claim 5, wherein in the step (S310) of recognizing objects of the child drawing, the number of objects and sizes of the objects are recognized and
in the step (S320) of recognizing colors of the child drawing, at least one of a coloring ratio, a primary color, a primary color usage ratio, a hue type, a tone ratio, and a color usage difference (std) are recognized,
in the step (S330) of recognizing lines of the child drawing, at least one of a pen pressure, a length, a thickness, a repetition, the number of times, and a speed of the line is recognized,
in the step (S340) of recognizing spaces of the child drawing, at least one of an occupancy ratio and a placement of the object is recognized, and
in the step (S350) of analyzing behavior data of a child, at least one of a drawing hour and the number of corrections is analyzed.

7. The child drawing understanding and analysis reporting method according to claim 1, wherein the interpretation indicator calculating step (S400) includes at least one of:
a step (S410) of diagnosing and testing the child drawing by a drawing diagnosis test model (141);
a step (S420) of clinically classifying the child drawing, by a child clinical classification model (142);
a step (S430) of classifying a general tendency of the child who draws the child drawing, by a child general tendency classification model (143);
a step (S440) of analyzing a development of the child drawing, by a child drawing development model (144); and
a step (S450) of analyzing the child drawing, by a child drawing analysis model (145); and
a step (S460) of storing and outputting an interpretation indicator output from the service model.

8. The child drawing understanding and analysis reporting method according to claim 7, wherein the drawing diagnosis test model outputs a stress indicator and a copying resource indicator as the interpretation indicator,
the child clinical classification model includes a depression indicator, an anxiety indicator, and an ADHD indicator as the interpretation indicator,
the child general tendency classification model includes a realistic indicator, an exploratory indicator, and an artistic indicator as the interpretation indicator,
the child drawing development model includes a scribbling stage indicator, a preschematic stage indicator, and a schematic stage indicator, as the interpretation indicator, and
the child drawing analysis model includes an aesthetic sensitivity indicator and an immersion indicator as the interpretation indicator.

9. The child drawing understanding and analysis reporting method according to claim 8, wherein the analysis report output step (S500) includes: a step of performing at least one of:
a step (S510) of generating a drawing diagnosis test report (161);
a step (S520) of generating a child emotion/psychology analysis report (162);
a step (S530) of generating a child tendency/carrier path analysis report (163);
a step (S540) of generating a child artistic tendency report (164); and
a step (S550) of generating an Art BONGBONG growth report (165), based on the interpretation indicator; and
a step (S560) of outputting the generated report.

10. The child drawing understanding and analysis reporting method according to claim 9, wherein the drawing diagnosis test report (161), the child artistic tendency report (164), and the Art BONGBONG growth report (165) are based on the interpretation indicators of the drawing diagnosis test model, the child drawing development model, and the child drawing analysis model, respectively and
the child emotion/psychology analysis report (162) and the child tendency/career path analysis report (163) are based on the interpretation indicators of the child clinical classification model (142) and the child general tendency classification model (143), respectively.
